(19) United States
(12) Patent Application Publication
(10) Pub. No.: US 2018/0034817 A1
(43) Pub. Date: Feb. 1, 2018

(54) Bulk Joining Of Computing Devices To An Identity Service

(71) Applicant: Microsoft Technology Licensing, LLC, Redmond, WA (US)

(72) Inventors: Victoria Elizabeth Milton, Woodinville, WA (US); Balaji K. Azhagiyapandiapuram, Redmond, WA (US); Yordan I. Rouskov, Seattle, WA (US); Jairo A. Cadena, Lake Stevens, WA (US); Marc Shepard, Bellevue, WA (US); Gary Scot Henderson, Redmond, WA (US); Venkatavaradhan Panchapagesam, Redmond, WA (US); Shrikesh Himanshu Tanna, Seattle, WA (US); Steven Joseph Tricanowicz, Seattle, WA (US); Niranjan Balwalli, Bothell, WA (US); Milind Ramesh Khairnar, Redmond, WA (US); Mark Steven Kruger, Kirkland, WA (US); Sushil Ganesh, Mercer Island, WA (US)

(73) Assignee: Microsoft Technology Licensing, LLC, Redmond, WA (US)

(21) Appl. No.: 15/221,393

(22) Filed: Jul. 27, 2016

(51) Int. Cl. H04L 29/06; H04L 9/32

(52) U.S. Cl. CPC H04L 63/10; H04L 63/064; H04L 63/08; H04L 9/3247

(57) ABSTRACT

Bulk joining of computing devices to an identity service is performed in two parts. In the first part, a user of a token retrieval device provides credentials to an identity service, which verifies the credentials and provides to the token retrieval device a bulk token for joining the service. In the second part, the bulk token obtained from the identity service is provided to each computing device in a group of multiple computing devices that are to join the identity service. Each computing device in the group of computing devices communicates with the identity service to join the identity service using the bulk token. The bulk token can be provided to each of the multiple computing devices in the group as part of a provisioning package that includes additional configuration information to be used to configure the computing devices in the group.

### BACKGROUND

Situations arise in which multiple computing devices are set up and managed as a group. For example, a school may have a cart of computing devices or a computing lab with multiple computing devices, a company or business may have a collection of computing devices that are used by various employees, and so forth. Configuring such computing devices in a bulk manner, however, remains a burdensome task.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, in a service that manages identities on a network, a request for a bulk token to join a group of multiple computing devices to a network object collection of the network is received from a first computing device on the network. The bulk token is provided to the first computing device. Subsequently, from each computing device of the group of multiple computing devices on the network, the bulk token as well as a request to join the computing device to the network object collection are received. For each target computing device of the group of multiple computing devices, the bulk token received from the requesting computing device is verified. For each computing device of the group of multiple computing devices from which the bulk token received is verified, the computing device is joined in the network object collection.

In accordance with one or more aspects, a bulk token obtained from an identity service by a token retrieval device is received. A request is communicated to the identity service to join a network object collection managed by the identity service, the request including the bulk token. Confirmation that the computing device has been joined to the network object collection is received from the identity service in response to the bulk token being verified by the identity service.

In accordance with one or more aspects, a request for a bulk token to enroll a group of multiple computing devices in a network object collection of a network is communicated to an identity service on the network. The bulk token is received from the identity service. In one or more implementations, a provisioning package that includes configuration information for each computing device of a group of multiple computing devices is generated, and the bulk token is included in the provisioning package.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example system implementing the bulk joining of computing devices to an identity service in accordance with one or more embodiments.

FIG. 2 is a flowchart illustrating an example process, performed by a token retrieval device, for implementing the bulk joining of computing devices to an identity service in accordance with one or more embodiments.

FIG. 3 is a flowchart illustrating an example process, performed by a group device, for implementing the bulk joining of computing devices to an identity service in accordance with one or more embodiments.

FIG. 4 is a flowchart illustrating an example process, performed by an identity service, for implementing the bulk joining of computing devices to an identity service in accordance with one or more embodiments.

FIG. 5 illustrates an example system generally that includes an example computing device that is representative of one or more systems and/or devices that may implement the various techniques described herein.

### DETAILED DESCRIPTION

Bulk joining of computing devices to an identity service is discussed herein. The identity service refers to a service on a network that manages accounts or identities on the network. To be managed by the service, a computing device enrolls in or joins the service. Once a computing device has enrolled in or joined the identity service various aspects of the computing device can be managed via the identity service, such as which programs are installed on the computing device, security settings for the computing device, which other computing devices or network resources can be accessed by the computing device, and so forth. The identity service identifies the computing device, and various management tools use that identity to communicate with the device. The techniques discussed herein provide for bulk joining of a service by a group of multiple computing devices in a quick and efficient manner.

The joining of a service for a group of multiple computing devices (also referred to herein as enrolling the group of multiple computing devices in the service) is performed in two parts. In the first part, a token retrieval device communicates with the identity service and requests a bulk token for joining the service. A user of the token retrieval device provides credentials (e.g., user name and password) to the identity service. Upon verifying the provided credentials, the identity service provides a bulk token to the token retrieval device. The bulk token can be used by multiple computing devices to join the identity service.

In the second part, the bulk token obtained from the identity service is provided to each computing device in a group of multiple computing devices that are to join the identity service. A provisioning package is also optionally provided to each computing device in the group of multiple computing devices, the provisioning package including various different configuration information such as computing device settings or parameters, files, instructions for execution, and so forth. Additionally or alternatively, configuration information can be provided to each computing device in the group of multiple computing devices in different manners. The bulk token can be provided to each computing device in the group independently of the provisioning package or alternatively can be included in the provisioning package.

Each computing device in the group of computing devices communicates with the identity service to join the identity service, and provides the bulk token to the identity service as part of this communication. The identity service verifies that the bulk token is valid (e.g., has not been tampered with and has not expired), and if verified the identity service joins the computing device to the identity service. The bulk token can optionally be associated with a particular one of multiple network object collections (e.g., domains) managed by the identity service, in which case the computing device is joined to the network object collection associated with the bulk token.

Each of the multiple computing devices in the group uses the bulk token to join the identity service. An administrator or other individual responsible for setting up the group of computing devices can provide the bulk token to each computing device (e.g., from a universal serial bus (USB) thumb drive), at which point a configuration module on the computing device automatically uses the bulk token to join the computing device to the identity service. The administrator or other individual responsible for setting up the group of computing devices can thus quickly and efficiently join the group of computing devices to the identity service.

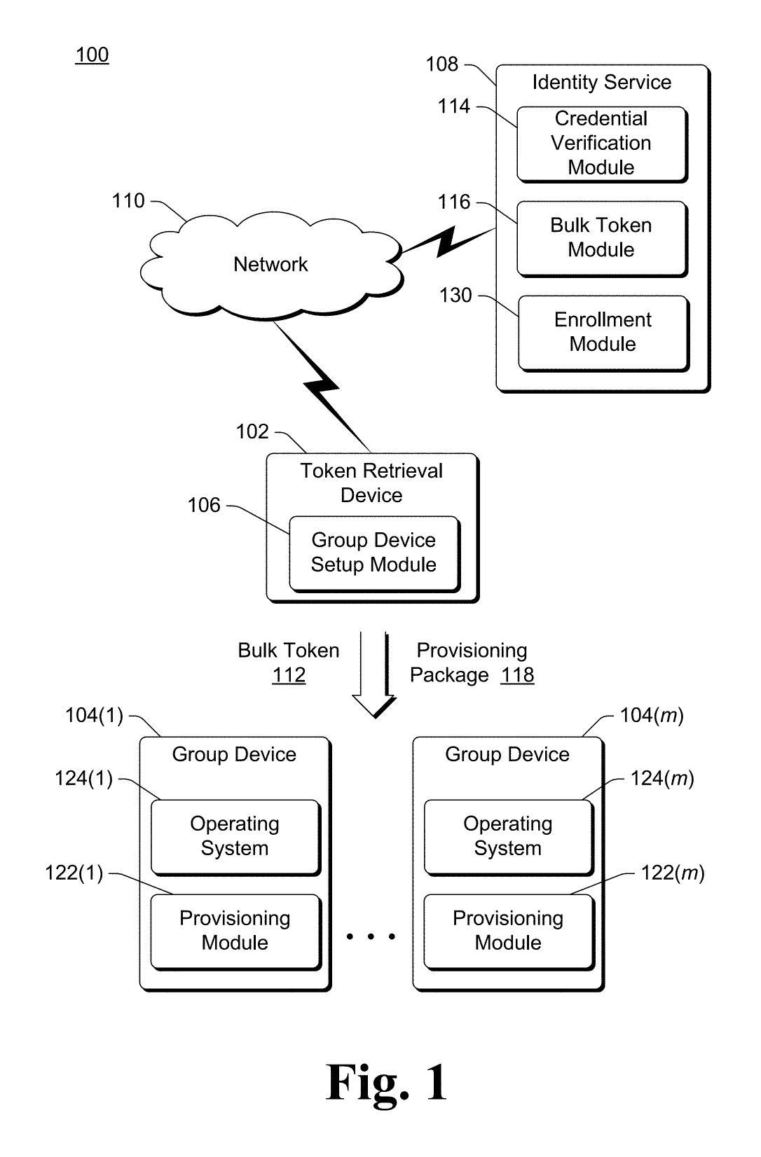

FIG. 1 illustrates an example system 100 implementing the bulk joining of computing devices to an identity service in accordance with one or more embodiments. The system 100 includes a token retrieval device 102, which can be a variety of different types of devices, such as a desktop computer, a laptop or netbook computer, a mobile device (e.g., a tablet or phablet device, a cellular or other wireless phone (e.g., a smartphone), a notepad computer, a mobile station), and so forth. Additionally or alternatively the token retrieval device 102 can be a variety of other types of computing devices, such as a server computer, a wearable device (e.g., eyeglasses, head-mounted display, watch, bracelet), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, the token retrieval device 102 may range from full resource devices with substantial memory and processor resources (e.g., personal computers, game consoles) to low-resource devices with limited memory and/or processing resources (e.g., traditional set-top boxes, hand-held game consoles).

The token retrieval device 102 is used to setup multiple (m) group devices 104(1), . . . , 104(m). The token can be used by anyone who has been granted the privileges to perform the bulk join of the multiple group devices 104 to the identity service 108, such as a user(s) or users within a group of users as defined in the identity service 108. Each group device 104 can be any of a variety of different types of devices. Oftentimes the different group devices 104 are the same types of devices, although alternatively different ones of the group devices 104 can be different types of devices. For example, a group device 104 can be a desktop computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, and so forth. Thus, each group device 104 may range from a full resource device with substantial memory and processor resources (e.g., personal computers, game consoles) to a low-resource device with limited memory and/or processing resources (e.g., traditional set-top boxes, hand-held game consoles).

The group devices 104 can be devices in any of a variety of environments in which an administrator or user desires to manage the group devices 104 collectively or independently. For example, the group devices may be laptop or table computers in a mobile cart at a school or on a factory floor, may be computing devices in a computing lab of a school or business, may be employee computing devices of a business or other organization, and so forth.

The token retrieval device 102 includes a group device setup module 106, which is a tool used to obtain a bulk token from an identity service 108 that is then used by the group devices 104 to join the group devices 104 to the identity service 108. The group device setup module 106 also optionally generates a provisioning package that is used to configure the group devices 104. In one or more embodiments, the group device setup module 106 is an application obtained by the group computing device 102 from an online application store or alternatively via other mechanisms, such as an original equipment manufacturer (OEM) preinstallation kit (OPK), as an operating system assessment and deployment kit (ADK), and so forth. Additionally or alternatively, the group device setup module 106 can be obtained in other manners, such as being pre-configured in the token retrieval device 102 or otherwise installed on or downloaded to the token retrieval device 102.

The token retrieval device 102 communicates with the identity service 108 via a network 110. Network 110 can be a variety of different networks, such as the Internet, a local area network (LAN), a public telephone network, an intranet, other public and/or proprietary networks, combinations thereof, and so forth. The identity service 108 can be any of a variety of different services or systems that manage accounts or identities on a network, and can be business oriented and/or consumer oriented services. For example, the identity service 108 can be an Active Directory® service, an Azure® Active Directory® service, a Microsoft® Account Service, and so forth.

In one or more embodiments, the identity service 108 supports multiple different collections of network objects. These network objects refer to computing devices, storage devices, network components, users, and so forth. Different collections of network objects can be treated as different groups by the identity service 108. These different collections of network objects can also be referred to as domains. Alternatively, the identity service 108 may support a single collection of network objects (e.g., a single domain).

Furthermore, in one or more embodiments the identity service 108 supports multiple different tenants. A tenant is an instance of the identity service 108, and multiple instances of the identity service 108 can be running on the same or different computing devices (e.g., servers). Each instance of the identity service 108 is distinct and separate from each other instance of the identity service 108, and each instance of the identity service 108 supports its own collection of network objects. Different companies, groups, organizations, or other entities can each have their own instance of the identity service 108.

In situations in which multiple different tenants exist, the bulk joining of computing devices to an identity service as discussed herein refers to the bulk joining of the group devices 104 to a particular tenant. Thus, the techniques discussed herein can be used to bulk join multiple group devices 104 to a particular instance of the identity service 108 in situations in which multiple different instances of the identity service 108 are running on a same set of one or more servers.

The group device setup module 106 obtains a bulk token 112 for the group devices 104. The group device setup module 106 obtains the bulk token 112 from identity service 108 in response to a user request received at the token retrieval device 102. The user request is a request for the bulk token, or a similar request (e.g., a request to generate a provisioning package). In one or more embodiments, different network object collections and/or instances of the identity service 108 are associated with different credentials, and the particular network object collection (e.g., domain) and/or instance of the identity service 108 for which a bulk token is requested is determined by the identity service 108 based on the credentials provided to the identity service 108 by the group device setup module 106. Additionally or alternatively, the user request can also specify a particular network object collection (e.g., domain) and/or instance of the identity service 108 for which a bulk token is requested. For example, different network object collections and/or instances of the identity service 108 have different names or identifiers, and the user can select or otherwise input an indication of one of the network object collection names and/or instances of the identity service 108.

The user provides credentials to log into the identity service 108. The provided credentials (or entity associated with the provided credentials) have the privileges needed to perform the joining of a device to the identity service 108. These credentials can be credentials of the user or alternatively credentials of other entities. Because the user provides the credentials, this can also referred to as the user having the privileges needed to perform the joining of a device to the identity service 108. These provided credentials can take various forms, such as user name and password, digital keys or passwords, biometric information, and so forth. The user or other entity associated with the credentials has previously enrolled in the identity service 108 and the identity service 108 verifies the provided credentials. The identity service 108 includes a credential verification module 114 that verifies the provided credentials and that the provided credentials have the privileges needed to perform the joining of a device to the identity service 108. E.g., the credential verification module 114 verifies that the credentials provided by the user match (e.g., are the same as) credentials previously provided to the identity service 108. If the credentials provided by the user match, then the credential verification module 114 verifies that the provided credentials have the privileges (e.g., are authorized by the identity service 108) to perform the joining of a device to the identity service 108.

The identity service 108 also includes a bulk token module 116. If the provided credentials are not verified by the credential verification module 114, then the identity service 108 does not provide a bulk token to the group device setup module 106. However, if the provided credentials are verified by the credential verification module 114, then the identity bulk token module 116 obtains a bulk token and provides the bulk token to the group device setup module 106. The bulk token module 116 can obtain the bulk token in different manners, such as generating the bulk token, requesting the bulk token from another device or system, retrieving the bulk token from a database or store of bulk tokens, and so forth.

The bulk token 112 includes one or more different parts. In one or more embodiments, the bulk token 112 includes an identifier of the bulk token 112. The identifier can take various different forms. For example, the identifier can be the user name of the user that requested the bulk token 112. If the user request for the bulk token specified a network object collection (e.g., domain), then the identifier can be a combination of (e.g., concatenation of) the network object collection name and the user name. By way of another example, the identifier can be an identifier that allows the bulk token 112 to be distinguished from other bulk tokens used by the identity service 108, such as a universally unique identifier (UUID) or globally unique identifier (GUID). An association between such an identifier and the user that requested the bulk token 112 (and optionally the network object collection name) can be maintained by the identity service 108, allowing the appropriate user name and/or network object collection name to be associated with a bulk token subsequently communicated to the identity service 108 by a group device 104.

The bulk token 112 optionally includes one or more additional parts containing additional information regarding the bulk token 112. In one or more embodiments, the bulk token 112 has an associated lifetime. This lifetime can be expressed in different manners, such as with an expiration time and/or date that indicates a time and/or data that the bulk token 112 expires and thus is no longer verified by the identity service 108. Additionally or alternatively, the lifetime can be expressed in other manners, such as with a time to live value that indicates how long (e.g., in hours, days, weeks, etc.) until the bulk token 112 expires from a particular start time (e.g., a time and/or date that the bulk token 112 was created, which can also be included as part of the bulk token 112).

Additionally or alternatively, the lifetime of the bulk token 112 can be managed separately by the identity service 108 and an indication of the lifetime need not be included in the bulk token 112. For example, the identity service 108 can maintain a table, database, or other record that includes an association between the bulk token 112 and the lifetime of the bulk token 112 (e.g., an expiration time and/or date, a time to live value, etc.), and can check this associated lifetime when subsequently verifying a bulk token received from a group device 104.

The bulk token 112 is a multi-use token, and is used by multiple group devices 104 to enroll the group devices 104 in the identity service 108 as discussed in more detail below. Thus, rather than a single-use token that is used solely by the token retrieval device 102 to enroll the token retrieval device 102 in the identity service 108, the bulk token 112 is used to enroll multiple group devices 104 in the identity service. The bulk token 112 can also optionally be used to enroll the token retrieval device 102 in the identity service 108.

The group device setup module 106 makes the bulk token 112 obtained from the identity service 108 available to each of the group devices 104. In one or more embodiments, the group device setup module 106 creates a provisioning package 118 that includes the bulk token 112. The provisioning package 118 is a file or other data structure that can be communicated to the group devices 104. The provisioning package 118 also includes various different configuration information for the group devices 104, such as computing device settings or parameters, files, instructions for execution, and so forth.

Each group device 104 includes a provisioning module 122 that obtains the provisioning package 118 and configures the group device 104 in accordance with the provisioning package 118. This configuration can include installing programs on the group device 104, setting various values or parameters for an operating system 124 on the group device 104, configuring security settings for the operating system 124 or other programs of the group device 104, and so forth. Alternatively, a provisioning package 118 may not be provided to the group devices 104, in which case configuration information is provided to the provisioning module 122 in other manners. However, the bulk token 112 is still provided to each group device 104, allowing the provisioning module 122 to use the bulk token 112 to join the group device 104 to the identity service 108.

The bulk token 112 and provisioning package 118 can be made available to the provisioning module 122 in a variety of different manners. In one or more embodiments, the bulk token 112 is included in the provisioning package 118, and thus the bulk token 112 is made available to the provisioning module 122 in the same manner as the provisioning package 118. Alternatively, the bulk token 112 can be made available to the provisioning module 122 separately from the provisioning package 118, and thus the bulk token 112 and the provisioning package 118 can be made available to the provisioning module 122 in two different manners.

For example, the bulk token 112 and/or provisioning package 118 can be stored on a universal serial bus (USB) drive and plugged into a USB port of the group device 104. Various other wired or wireless communication protocols can additionally or alternatively be used, such as near field communication (NFC), wireless USB, and so forth.

By way of another example, the bulk token 112 and/or provisioning package 118 can be obtained via a network location (e.g., a server or other device on the network 110). The provisioning module 122 accesses a network location, such as via a link (e.g., a uniform resource locator (URL)) indicating the network location, to obtain the bulk token 112 and/or provisioning package 118 via the network 110. The network location can be obtained by the provisioning module 122 in different manners, such as being pre-configured in the provisioning module 122, being provided to the provisioning module 122 via a USB drive plugged into a USB port of the group device 104, by a quick response (QR) code, and so forth. For example, a QR code can be displayed by the token retrieval device 102 (or transferred to another device for display). A camera or other imaging sensor of the group device 104 captures and provides the QR code to the provisioning module 122, which decodes the QR code. Embedded in the QR code can be a link indicating a network location to access via the network 110 to obtain the bulk token 112 and/or provisioning package 118. As part of providing the network location to the group device 104 (whether by USB drive, QR code, or other technique), credentials such as wireless network name (e.g., service set identifier (SSID) and optionally password) allowing the group device 104 to access the network can also be provided to the group device 104.

Providing the provisioning package 118 to the group devices 104 via a network location allows changes to be easily made to the configuration information and automatically applied to the group devices 104. For example, rather than changing the configuration information on one or more USB drives, the configuration information at the network location can be changed once and accessed by all the group devices that are joining the identity service 108.

The provisioning module 122 of a particular group device 104 uses the bulk token 112 to join the group device 104 to the identity service 108 and the configuration information in the provisioning package 118 to configure that particular group device 104. The provisioning module 122 can automatically join the group device 104 to the identity service 108 in response to receipt of the bulk token 112, or alternatively can join the group device 104 to the identity service 108 in response to some other action or event (e.g., a user request input to the group device 104 to enroll the group device 104 in the identity service 108). Similarly, the provisioning module 122 can automatically configure the group device 104 in accordance with the configuration information in the provisioning package 118 in response to receipt of the provisioning package 118, or alternatively can configure the group device 104 in accordance with the configuration information in the provisioning package 118 in response to some other action or event (e.g., a user request input to the group device 104 to configure the group device 104 in accordance with the provisioning package 118).

To join a group device 104 to the identity service 108, the provisioning module 122 on that group device communicates an enrollment request to the identity service 108. The identity service 108 includes an enrollment module 130 that receives and responds to the enrollment request. The enrollment module 130 verifies the bulk token received with the enrollment request, and this verification can take various forms. In one or more embodiments, the verification includes verifying that the bulk token has not expired (e.g., the current date and/or time is still within the lifetime of the bulk token). Additionally or alternatively, the verification includes other actions. For example, the identity service 108 can digitally sign the bulk token prior to sending the bulk token to the token retrieval device 102. This digital signing can be performed using various techniques, such as based on a symmetric key known only to the identity service 108, using the private key of a public/private key pair of the identity service 108, and so forth. The enrollment module 130 can, as part of the verification of the bulk token, verify the digital signature of the bulk token and thereby verify that the bulk token has not been altered since being sent to the token retrieval device 102 by the identity service 108.

If the bulk token is verified, then the enrollment module 130 joins the group device 104 to the identity service 108. If the bulk token specified a particular network object collection (e.g., domain), then the enrollment module 130 joins the group device 104 to that specified network object collection. Joining the group device 104 to the identity service 108 refers to the group device 104 relying on the identity service 108 as a trust authority. This means the group device 104 is able to retrieve a valid token from the identity service 108 for applications and/or services that ask the identity service 108 to authenticate and authorize access (e.g., to those applications and/or services).

The provisioning module 122 also performs various different configuration operations on the group device 104 as indicated by the provisioning package 118. These configuration operations can include setting particular values or parameters of the operating system 124 and/or another program of the group device 104, installing programs on the group device 104, copying data to the group device 104, removing programs or data from the group device 104, and so forth.

This process is repeated for each group device 104. Thus, it can be seen that the use of the bulk token 112 allows the provisioning modules 122 of the various group devices 104 to automatically join the group devices 104 to the identity service 108 (and optionally to a particular network object collection of the identity service). The administrator or user need not manually enter credentials at each group device 104 in order to join the group device 104 to the identity service 108. Rather, after obtaining the bulk token at the token retrieval device 102, the administrator or user can simply plug in a USB drive to a particular group device 104 or otherwise provide the bulk token 112 to a particular group device 104. The provisioning module 122 of the particular group device 104 can then automatically use the bulk token 112 to join the identity service 108, or alternatively can use the bulk token 112 to join the identity service 108 in response to a simple join or enroll request (e.g., the user pressing a button or selecting a menu item requesting that the group device 104 be joined to the identity service 108).

The administrator or user can then proceed to the next group device 104 and repeat this process of plugging in the USB drive to another group device 104 or otherwise provide the bulk token 112 to that other group device 104. The administrator or user can proceed with providing the bulk token to the other group device 104 even while the previous group device 104 is in the process of joining itself to the identity service 108 and/or performing configuration operations based on the provisioning package 118. The provisioning module 122 can optionally display or otherwise present an indication to the administrator or user that the provisioning module 122 has received the bulk token (and optionally the provisioning package 118), notifying the administrator or user that he or she can proceed to the next group device. The administrator or user need not sit and monitor the identity service joining or the configuration operations—these proceed automatically freeing the administrator or user to begin the process on the next group device 104. A single administrator or user can thus quickly and easily set up a large number (tens, hundreds, or even thousands) of group devices to join the identity service 108 and have the configuration operations performed on the group devices.

Additionally or alternatively, if the bulk token 112 is provided to the group devices 104 via a network (e.g., using any of various wired or wireless communication protocols as discussed above), then multiple group devices 104 can use the bulk token 112 simultaneously to join the identity service 108.

It should be noted that the use of the bulk token 112 and the provisioning package 118 allows some configuration of each of the group devices 104 to be performed. This configuration includes joining the group devices 104 to the identity service 108, and various additional configuration operations as discussed above. This configuration is done without access to or logging into a device management service such as a mobile device management (MDM) service. Although the group devices 104 may subsequently be joined into and managed by an MDM service or other device management service, such joining is not necessary to perform the identity service join and configuration operations discussed herein.

Similarly, it should be noted that the use of the bulk token 112 and the provisioning package 118 allows some configuration of each of the group devices 104 to be performed without access to or receiving information from a separate configuration service provider. A configuration service provider refers to a system or service to read, set, modify, etc. various configuration settings on the group devices. Although the group devices 104 may subsequently access a configuration service provider, the joining of the group devices 104 to the identity service and the various additional configuration operations discussed above are done without needing to access a configuration service provider.

In one or more embodiments, the identity service maintains a record of each group device 104 that joins the identity service 108 (or a network object collection of the identity service 108) using the bulk token 112. Various operations can subsequently be performed across all of the group devices 104. For example, an administrator of the identity service 108 may desire to apply a particular policy to all of the group devices 104, install a particular program on all of the group devices 104, unenroll the group devices 104 from the identity service 108, and so forth. The same bulk token was used to join all of the group devices 104 to the identity service 108, so these group devices 104 can be readily identified and the appropriate action taken as desired by the administrator of the identity service 108 (e.g., particular policy applied, application installed, unenrollment from the identity service, and so forth). Maintaining a record of the bulk token 112 also allows the identity service 108 to avoid using the same bulk token for multiple different groups of devices.

The record of each group device 104 that joins the identity service 108 (or a network object collection of the identity service 108) using the bulk token 112 can also be made available to other services, such as an MDM service or other device management system. This facilitates management of the group devices 104 by providing the MDM service or other device management system with an indication of all of the group devices 104 that an administrator or user of the token retrieval device 102 desires to have treated together (by virtue of using the same bulk token 112 to join those group devices 104 to the identity service 108).

Although the use of the bulk token 112 allows the group devices 104 to be treated as a group and operations performed across all of the group devices 104, the group devices 104 can still be managed independently if desired. Each group device 104 is joined to the identity service 108 and is uniquely identified (at least within the identity service 108) and addressable, allowing independent and/or group treatment of the multiple group devices 104.

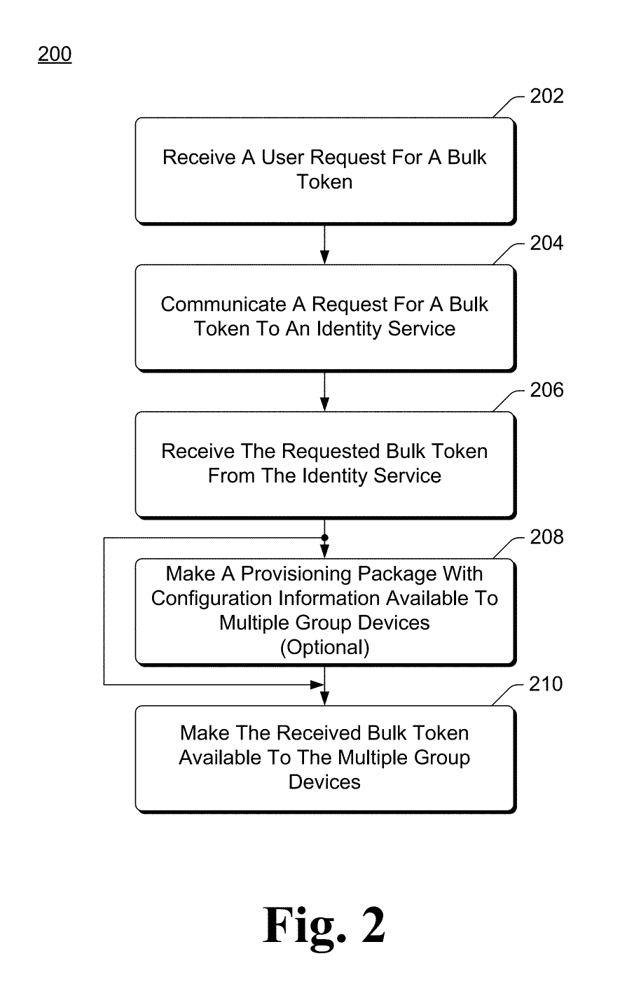

FIG. 2 is a flowchart illustrating an example process 200 for implementing the bulk joining of computing devices to an identity service in accordance with one or more embodiments. Process 200 is carried out by a token retrieval device, such as the token retrieval device 102 of FIG. 1, and can be implemented in software, firmware, hardware, or combinations thereof. Process 200 is shown as a set of acts and is not limited to the order shown for performing the operations of the various acts. Process 200 is an example process for implementing the bulk joining of computing devices to an identity service; additional discussions of implementing the bulk joining of computing devices to an identity service are included herein with reference to different figures.

In process 200, a user request for a bulk token is obtained (act 202). The user request is received via, for example, a group device setup module of the token retrieval device. The user request is a request for the token retrieval device to obtain a bulk token to use to join multiple group devices to an identity service, and optionally join the multiple group devices to a specific network object collection (e.g., domain) of the identity service.

In response to the user request, the token retrieval device communicates a request for the bulk token to an identity service (act 204). The request also includes credentials for a user of the token retrieval device or other entity with the privileges used to join a device to the identity service.

The requested bulk token is received from the identity service (act 206). In one or more embodiments, the requested bulk token is received only if the credentials provided to the identity service in act 204 are verified. This verification includes verification that the provided credentials have the privileges (e.g., are authorized by the identity service) to perform the joining of a device to the identity service as discussed above.

A provisioning package with configuration information is optionally made available to the multiple group devices (act 208). The provisioning package includes various configuration information such as programs, data, operating system settings and values, and so forth as discussed above. The provisioning package can be made available to the multiple group devices in various manners as discussed above, such as via a USB drive, via a network location accessed by the group devices, and so forth. It should be noted that making a provisioning package available to the multiple group devices is optional—configuration information can additionally or alternatively be made available to multiple group devices in other manners (e.g., via a configuration service provider).

The received bulk token is made available to the multiple group devices (act 210). The bulk token can be included in a provisioning package made available to the multiple group devices in act 208, or alternatively can be made available separately. The bulk token can be made available to the multiple group devices in various manners as discussed above, such as via a USB drive, via a network location accessed by the group devices, and so forth.

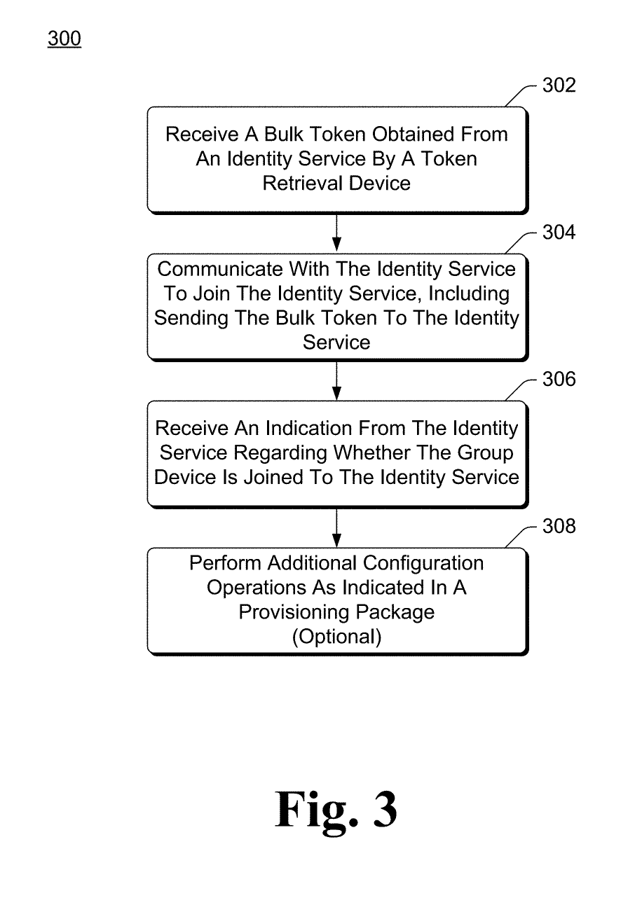

FIG. 3 is a flowchart illustrating an example process 300 for implementing the bulk joining of computing devices to an identity service in accordance with one or more embodiments. Process 300 is carried out by a group device, such as a group device 104 of FIG. 1, and can be implemented in software, firmware, hardware, or combinations thereof. Process 300 is shown as a set of acts and is not limited to the order shown for performing the operations of the various acts. Process 300 is an example process for implementing the bulk joining of computing devices to an identity service; additional discussions of implementing the bulk joining of computing devices to an identity service are included herein with reference to different figures.

In process 300, a bulk token obtained from an identity service by a token retrieval device is received (act 302). The bulk token can be received in various manners, such as via a USB drive, from a network location, and so forth as discussed above.

The group device communicates with the identity service to join the identity service (act 304). The communication includes sending the bulk token to the identity service for verification. The bulk token can be used to join the identity service, or optionally a particular network object collection (e.g., domain) of the identity service as discussed above. The credentials provided to obtain the bulk token (e.g., in act 204 of FIG. 2) need not be provided to the identity service by the group device because the group device has the bulk token.

An indication is received from the identity service regarding whether the group device is joined to the identity service (act 306). Whether the group device is joined to the identity service is dependent on whether the bulk token is verified as discussed above.

Additional configuration operations as indicated in a provisioning package are optionally performed on the group device (act 308). Various different configuration operations can be performed as discussed above, such as installing of programs, setting particular values of an operating system or other program, and so forth. It should be noted that performing additional configuration operations in act 308 is optional, and may not be performed as part of the process of joining the group device to the identity service. It should also be noted that if additional configuration operations are performed, indications of such operations can additionally or alternatively be obtained in manners other than via the provisioning package.

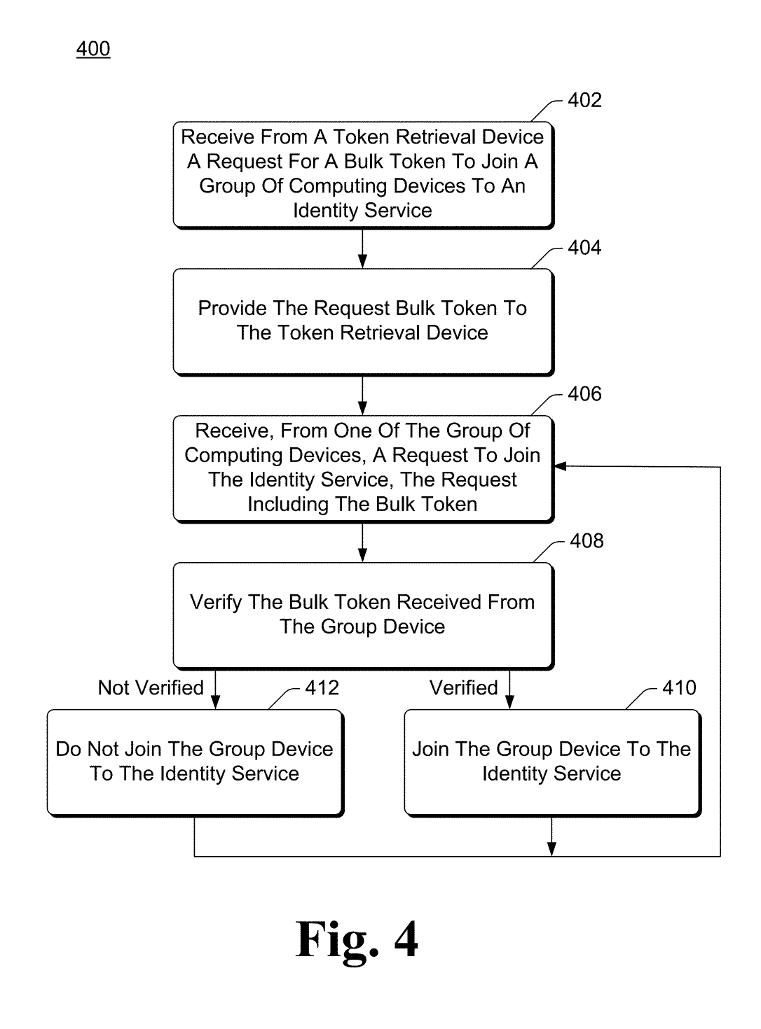

FIG. 4 is a flowchart illustrating an example process 400 for implementing the bulk joining of computing devices to an identity service in accordance with one or more embodiments. Process 400 is carried out by an identity service, such as the identity service 108 of FIG. 1, and can be implemented in software, firmware, hardware, or combinations thereof. Process 400 is shown as a set of acts and is not limited to the order shown for performing the operations of the various acts. Process 400 is an example process for implementing the bulk joining of computing devices to an identity service; additional discussions of implementing the bulk joining of computing devices to an identity service are included herein with reference to different figures.

In process 400, a request for bulk token to join a group of computing devices to the identity service is received (act 402). The request can optionally be for a bulk token to join a group of computing devices to a particular network object collection (e.g., domain) of the identity service.

The requested bulk token is obtained and provided to the token retrieval device (act 404). The bulk token can include various different parts as discussed above, and also has an associated lifetime as discussed above.

A request to join the identity service is subsequently received from one of the group of computing devices (act 406). This request to join the identity service includes the bulk token previously provided to the token retrieval device. This request to join the identity service can optionally be a request to join a particular network object collection (e.g., domain) of the identity service, as discussed above.

The bulk token received from the group device is verified (act 408). This verification can take various forms as discussed above, such as verification that a current date and/or time is within a lifetime of the bulk token, verification of a digital signature of the bulk token, and so forth.

Process 400 proceeds based on whether the bulk token received from the group device is verified. If the bulk token is verified, then the group device from which the bulk token is received is joined to the identity service (act 410). This joining is optionally joining of the group device to a particular network object collection (e.g., domain) and/or tenant specified by the bulk token. However, if the bulk token is not verified, then the group device from which the bulk token is received is not joined to the identity service (act 412).

Regardless of whether a particular group device is joined to the identity service, process 400 returns to receive another request to join the identity service from another one of the group of computing devices in act 406. Thus, the identity service receives multiple requests from multiple group devices to join the identity service, and determines on a group device by group device basis whether to join each group device in the identity service.

Returning to FIG. 1, it should be noted that although a particular administrator or user obtains the bulk token using the token retrieval device and can subsequently use that bulk token to join the group devices 104 to the identity service 108, other users are still able to log into and use the group devices 104. Once the group device 104 is joined to the identity service 108 (or a network object collection of the identity service 108), other users can use that group device to log into that same identity service 108 (or that same network object collection of the identity service 108).

The techniques discussed herein reduce the labor and user time spent in joining a group device to an identity service. Furthermore, by automating the joining of the group devices to the identity service using the bulk token, there are fewer user inputs to provide and thus the possible incorrect requests or incorrect option selections are reduced, thereby improving the reliability of the group device. Additionally, network communications and network data usage can be reduced due to use of a single set of credentials to join multiple group devices to an identity service.

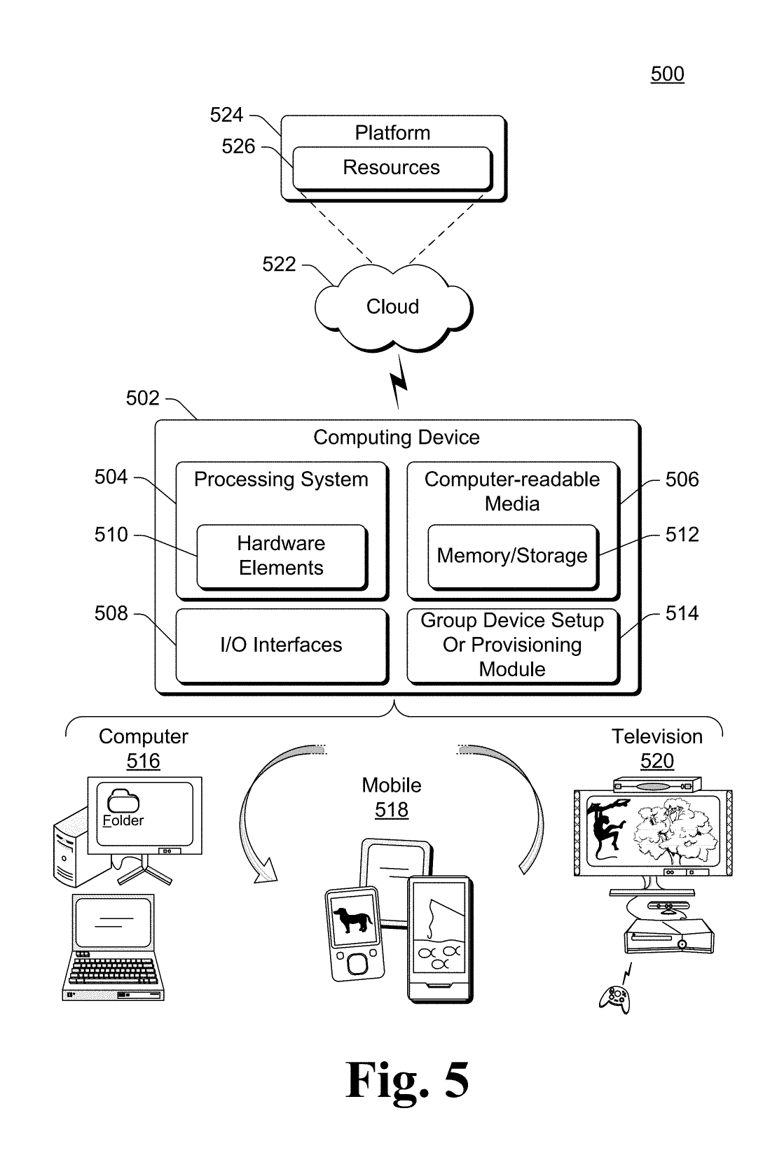

FIG. 5 illustrates an example system generally at 500 that includes an example computing device 502 that is representative of one or more systems and/or devices that may implement the various techniques described herein. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O Interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

The one or more input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

The computing device 502 includes a group device setup or provisioning module 514. In one or more embodiments, the computing device 502 is a token retrieval device, such as the token retrieval device 102 of FIG. 1, in which case the computing device 502 includes a group device setup module 514, which can be a group device setup module 106 of FIG. 1. Alternatively, if the computing device 502 is a group device, such as one of the group devices 104 of FIG. 1, then the computing device 502 need not include the group device setup module but would include a provisioning module 514, which can be a provisioning module 122 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 502 may assume a variety of different configurations, such as for computer 516, mobile 518, and television 520 uses. Each of these configurations includes devices that may have generally different constructs and capabilities, and thus the computing device 502 may be configured according to one or more of the different device classes. For instance, the computing device 502 may be implemented as the computer 516 class of a device that includes a personal computer, desktop computer, a multi-screen computer, laptop computer, netbook, and so on.

The computing device 502 may also be implemented as the mobile 518 class of device that includes mobile devices, such as a mobile phone, portable music player, portable gaming device, a tablet computer, a multi-screen computer, and so on. The computing device 502 may also be implemented as the television 520 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This functionality may also be implemented all or in part through use of a distributed system, such as over a “cloud” 522 via a platform 524 as described below.

The cloud 522 includes and/or is representative of a platform 524 for resources 526. The platform 524 abstracts underlying functionality of hardware (e.g., servers) and software resources of the cloud 522. The resources 526 may include applications and/or data that can be utilized while computer processing is executed on servers that are remote from the computing device 502. Resources 526 can also include services provided over the Internet and/or through a subscriber network, such as a cellular or Wi-Fi network.

The platform 524 may abstract resources and functions to connect the computing device 502 with other computing devices. The platform 524 may also serve to abstract scaling of resources to provide a corresponding level of scale to encountered demand for the resources 526 that are implemented via the platform 524. Accordingly, in an interconnected device embodiment, implementation of functionality described herein may be distributed throughout the system 500. For example, the functionality may be implemented in part on the computing device 502 as well as via the platform 524 that abstracts the functionality of the cloud 522.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method implemented in a service that manages identities on a network, the method comprising: receiving, from a first computing device on the network, a request for a bulk token to join a group of multiple computing devices to a network object collection of the network; providing, to the first computing device, the bulk token; subsequently receiving, from each computing device of the group of multiple computing devices on the network, both a request to join the computing device to the network object collection and the bulk token; verifying, for each computing device of the group of multiple computing devices, the bulk token received from the computing device; and joining, for each computing device of the group of multiple computing devices from which the bulk token received is verified, the computing device in the network object collection.

Alternatively or in addition to any of the above described methods, any one or combination of: the network object collection comprising a domain; the verifying comprising verifying that a current time is within a lifetime of the bulk token; an indication of the lifetime of the bulk token being included in the bulk token; an identification of the network object collection being included in the bulk token; the lifetime of the bulk token comprising multiple days; the verifying comprising verifying a digital signature of the bulk token; the method further comprising verifying a requestor has privileges to perform a join to the identity service for the network object collection, and providing the bulk token to the first computing device in response to determining that the requestor has privileges to perform a join to the identity service for the network object collection; the method further comprising maintaining a record of all of the multiple computing devices joined to the network object collection using the bulk token; the method further comprising providing the record to a device management system.

A computing device comprising: a processor; and a computer-readable storage medium having stored thereon multiple instructions that, responsive to execution by the processor, cause the processor to perform acts comprising: receiving a bulk token obtained from an identity service by a token retrieval device; communicating a request to the identity service to join a network object collection managed by the identity service, the request including the bulk token; and receiving, from the identity service in response to the bulk token being verified by the identity service, confirmation that the computing device has been joined to the network object collection.

Alternatively or in addition to any of the above described computing devices, any one or combination of: wherein receiving the bulk token comprises receiving the bulk token as part of a provisioning package that includes additional configuration information identifying configuration operations to perform on the computing device; the acts further comprising performing the configuration operations on the computing device without accessing a device management service; the acts further comprising performing the configuration operations on the computing device without accessing a configuration service provider; the acts further comprising performing the configuration operations on the computing device after a user of the computing device has left the computing device and begun joining of an additional computing device to the network object collection; wherein receiving the bulk token comprises receiving the bulk token from a network location; wherein receiving the bulk token comprises receiving the bulk token from a USB drive plugged into the computing device.

A computing device comprising: a processor; and a computer-readable storage medium having stored thereon multiple instructions that, responsive to execution by the processor, cause the processor to perform acts comprising: communicating, to an identity service on a network, a request for a bulk token to enroll a group of multiple computing devices in a network object collection of the network; receiving, from the identity service, the bulk token; generating a provisioning package that includes configuration information for each computing device of the group of multiple computing devices; and including, in the provisioning package, the bulk token.

Alternatively or in addition to any of the above described computing devices, any one or combination of: the acts further comprising storing the provisioning package on a USB drive; the network object collection comprising a domain.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a service that manages identities on a network, the method comprising:
receiving, from a first computing device on the network, a request for a bulk token to join a group of multiple computing devices to a network object collection of the network;
providing, to the first computing device, the bulk token;
subsequently receiving, from each computing device of the group of multiple computing devices on the network, both a request to join the computing device to the network object collection and the bulk token;
verifying, for each computing device of the group of multiple computing devices, the bulk token received from the computing device; and
joining, for each computing device of the group of multiple computing devices from which the bulk token received is verified, the computing device in the network object collection.

2. The method as recited in claim 1, the network object collection comprising a domain.

3. The method as recited in claim 1, the verifying comprising verifying that a current time is within a lifetime of the bulk token.

4. The method as recited in claim 3, an indication of the lifetime of the bulk token being included in the bulk token.

5. The method as recited in claim 3, an identification of the network object collection being included in the bulk token.

6. The method as recited in claim 3, the lifetime of the bulk token comprising multiple days.

7. The method as recited in claim 1, the verifying comprising verifying a digital signature of the bulk token.

8. The method as recited in claim 1, further comprising:
verifying a requestor has privileges to perform a join to the identity service for the network object collection; and
providing the bulk token to the first computing device in response to determining that the requestor has privileges to perform a join to the identity service for the network object collection.

9. The method as recited in claim 1, further comprising maintaining a record of all of the multiple computing devices joined to the network object collection using the bulk token.

10. The method as recited in claim 9, further comprising providing the record to a device management system.

11. A computing device comprising:
a processor; and
a computer-readable storage medium having stored thereon multiple instructions that, responsive to execution by the processor, cause the processor to perform acts comprising:
receiving a bulk token obtained from an identity service by a token retrieval device;
communicating a request to the identity service to join a network object collection managed by the identity service, the request including the bulk token; and
receiving, from the identity service in response to the bulk token being verified by the identity service, confirmation that the computing device has been joined to the network object collection.

12. The computing device as recited in claim 11, wherein receiving the bulk token comprises receiving the bulk token as part of a provisioning package that includes additional configuration information identifying configuration operations to perform on the computing device.

13. The computing device as recited in claim 12, the acts further comprising performing the configuration operations on the computing device without accessing a device management service.

14. The computing device as recited in claim 12, the acts further comprising performing the configuration operations on the computing device without accessing a configuration service provider.

15. The computing device as recited in claim 12, the acts further comprising performing the configuration operations on the computing device after a user of the computing device has left the computing device and begun joining of an additional computing device to the network object collection.

16. The computing device as recited in claim 11, wherein receiving the bulk token comprises receiving the bulk token from a network location.

17. The computing device as recited in claim 11, wherein receiving the bulk token comprises receiving the bulk token from a USB drive plugged into the computing device.

18. A computing device comprising:
a processor; and
a computer-readable storage medium having stored thereon multiple instructions that, responsive to execution by the processor, cause the processor to perform acts comprising:
communicating, to an identity service on a network, a request for a bulk token to enroll a group of multiple computing devices in a network object collection of the network;
receiving, from the identity service, the bulk token;
generating a provisioning package that includes configuration information for each computing device of the group of multiple computing devices; and
including, in the provisioning package, the bulk token.

19. The computing device as recited in claim 18, the acts further comprising storing the provisioning package on a USB drive.

20. The computing device as recited in claim 18, the network object collection comprising a domain.
